(19) United States
(12) Patent Application Publication
(10) Pub. No.: US 2008/0253376 A1
(43) Pub. Date: Oct. 16, 2008

(54) Method and Arrangement for Verifying an Originating Address Transmitted in a Call Request for the Purpose of Establishing a Communications Link in an Ip Communications Network

(75) Inventor: Joachim Charzinski, Munchen (DE)

Correspondence Address: BELL, BOYD & LLOYD, LLP, P.O. BOX 1135, CHICAGO, IL, 60690, US

(73) Assignee: Nokia Siemens Networks GmbH & Co., KG, Munchen (DE)

(21) Appl. No.: 12/088,835

(22) PCT Filed: Aug. 22, 2006
(86) PCT No.: PCT/EP2006/065535

§ 371 Date: Apr. 14, 2008

(30) Foreign Application Priority Data
Sep. 30, 2005 (DE) 10 2005 046 965.5

(51) Int. Cl. H04L 12/58

(52) U.S. Cl. 370/395.2

(57) ABSTRACT

The invention relates to a method for verifying an originating address transmitted in a call request for the purpose of establishing a communications link in an IP communications network between a user terminal of a first subscriber (A) and a terminal of a second subscriber (B). The transmitted originating address is verified before the communications link is established by way of a confirmation request of the terminal of the second subscriber (B) to the transmitted originating address and evaluation of a response to the confirmation request by the terminal of the second subscriber (B).

### CLAIM FOR PRIORITY

This application is a national stage application of PCT/EP2006/065535, filed Aug. 22, 2006, which claims the benefit of priority to German Application No. 10 2005 046 965.5, filed Sep. 30, 2005, the contents of which hereby incorporated by reference.

### TECHNICAL FIELD OF THE INVENTION

The invention relates to a method and to an arrangement for verifying an originating address transmitted in a call request for the purpose of establishing a communications link in an IP communications network.

### BACKGROUND OF THE INVENTION

The term “spamming” designates the sending out of masses of unwanted messages (“spam”). Spamming is furthered by the simple and advantageous access to electronic media which, as a rule, enable messages to be sent out to a large number of receivers with little time and cost expenditure. The content of such spam messages is frequently of a commercial type, spam of dubious content predominating above all. A well known form of spam is the sending out of masses of emails for advertising purposes. Apart from email spam, there are other forms such as, for example, spam with respect to instant messaging, Usenet newsgroups, www. search engines, weblogs or mobile radio.

As already mentioned, spam is furthered by the fact that spamming produces almost no effective costs, apart from the administration of corresponding email address lists, for the originators, for example advertisers. Apart from the obvious disadvantages produced for the respective receivers by the sending out of unwanted messages, spamming now results in high costs which must be borne by the general public. On the one hand, these are indirect costs which arise, for example, due to loss of productivity or excessively filled electronic mailboxes. Even more serious are the costs arising through the providers of infrastructure affected in each case, for example Internet service providers (ISP): frequently, the bandwidth capacities must be increased since the existing bandwidths are no longer sufficient for coping with the flood of spam.

Although spamming is ostracized by the general public and the legal position is currently being adapted in Germany and other countries, spamming is still increasing since the barrier for this type of message transmission is very small.

With the increasing spread of internet telephony (Voiceover IP, VoIP in brief), it is expected that VoIP subscribers will be increasingly exposed to so-called SPIT (SPAM over Internet Telephony). At present, advertising calls to conventional PSTN (Public Switched Telephone Network) subscribers are normally always charged to the caller. Calls to VoIP subscribers, in contrast, can be conducted almost free of cost for the caller due to the different charging model which leads to the expectation of a massive SPIT volume for the future. It is particularly the possibility of sending out masses of recorded voice files which would be of interest to advertisers. It must be assumed that the affected VoIP subscribers will request their respective VoIP provider to take suitable measures in order to be protected against unwanted calls.

Whereas connections in PSTN are circuit-switched, or in mobile radio an identification can be carried out via the SIM card of the caller, identification of a caller presents problems in IP telephony: the communication between two subscribers in this case now only takes place virtually from end point to end point since these are packet-switched connections.

As a counter measure against SPIT, so called white lists and/or black lists are used, among other things. For a subscriber X, a white list contains subscriber-specific information relating to such other subscribers Y in the communications network which are graded as trustworthy and are thus authorized to call subscriber X. A black list contains the same subscriber-specific information as a white list, but in a black list, untrustworthy subscribers are entered, the calls of which are automatically rejected, in principle.

However, such white and black lists do not offer any protection against SPIT if a SPIT originator, for example, forges his originating address in the SIP header of the SPIT message by using, for example, an originating address from the white list of the called subscriber X maliciously as his originating address.

In the case where a communications network is composed of a number of communications subnetworks, each network operator has hitherto separately ensured that a subscriber authenticates himself, for example with user name and password. The authentication is checked, for example, on an SIP server of a network operator who checks whether the subscriber is authorized to use the originating address specified by him. Network operators of in each case adjacent communications subnetworks trust that the respective neighbor also checks the authentication of each subscriber. As soon as a communications subnetwork deviates from this scheme, however, for example due to a misconfigured SIP server, the security standard drops for all communications subnetworks and thus for the entire communications network since non-authenticated messages and/or messages provided, for example, with a forged originating address can be injected into the communications network via an insecurely configured communications subnetwork.

### SUMMARY OF THE INVENTION

The invention relates to a method and an arrangement for verifying an originating address transmitted in a call request for establishing a communications link in an IP communications network.

In one embodiment of the invention, there is a method for verifying an originating address transmitted in a call request for the purpose of establishing a communications link in an IP communications network between a terminal of a first subscriber and a terminal of a second subscriber. The originating address transmitted is verified before the establishment of the communications link by means of an acknowledgement request of the terminal of the second subscriber to the transmitted originating address and an evaluation of a response to the acknowledgement request by the terminal of the second subscriber. A terminal, the address of which matches the transmitted originating address, transmits an acknowledgement to the terminal of the second subscriber in the case where the terminal is identical with the terminal of the first subscriber. In the case where the terminal is not identical with the terminal of the first subscriber, the terminal transmits a message corresponding to a rejection to the terminal of the second subscriber.

The invention also relates to an arrangement and devices for carrying out the method represented.

The invention is advantageous in one respect since an originating address can be verified in an IP communications network.

### BRIEF DESCRIPTION OF THE DRAWINGS

An exemplary embodiment of the invention is shown in the drawings and will be described in greater detail in the text which follows.

FIG. 1 shows a VoIP communications network with two subscribers A and B.

FIG. 2 shows a VoIP communications network with two subscribers A, B and a SPIT originator M.

FIG. 3 shows signaling and voice connection in connection with FIG. 1.

FIG. 4 shows signaling and voice connection in connection with FIG. 2.

### DETAILED DESCRIPTION OF THE INVENTION

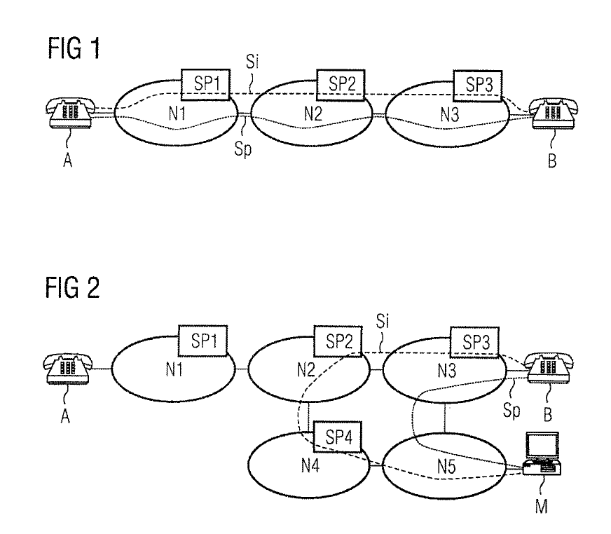

FIG. 1 shows a VoIP communications network with a first subscriber A who is calling a second subscriber B. Furthermore, a first, a second and a third communications subnetwork N1, N2, N3 with a first, a second and a third SIP server SP1, SP2, SP3 are shown. The SIP servers SP1, SP2, SP3 are preferably represented by soft switches or SIP proxies. FIG. 1 also shows the signaling route Si for the call and the voice connection Sp, resulting from the call, between the first subscriber A and the second subscriber B. In this exemplary embodiment, the signaling route Si leads from a terminal of the first subscriber A via the SIP servers SP1, SP2, SP3 of the communications subnetworks N1, N2, N3 to a terminal of the second subscriber B. The network architecture shown only represents one exemplary embodiment. Other variants of the architecture are conceivable.

FIG. 2 shows a similar network architecture as shown in FIG. 1 but extended by a fourth and fifth communications subnetwork N4, N5 and a fourth SIP server Sp4. Furthermore, FIG. 2 shows a SPIT originator M. The SPIT originator M uses, for example, a weakness in the configuration of the fourth SIP server SP4 in the fourth communications subnetwork N4: this weakness in the configuration allows, for example, that external callers can signal their calls via the fourth SIP server SP4. Even if the operator of the third communications subnetwork N3 demanded that SIP servers operated by him should only receive signaling information from known adjacent SIP servers, use of the weakness in the configuration could not be prevented if one of the adjacent SIP servers did not also enforce this restriction itself. Between the insecurely configured communications subnetwork N4 and the communications subnetwork N3, several further communications subnetworks can be located so that the configurations can no longer be controlled by neighbor relations of the network operators. The SPIT originator M can thus access the fourth SIP server SP4 in the fourth communications subnetwork N4 via a fifth communications subnetwork N5 and signal a call with the originating address of the first subscriber A to the second subscriber B. If the first subscriber A is located on a white list of the second subscriber B, the SPIT originator M can make use of this fact and thus place a call to the second subscriber B which he could not do specifying his own originating address. In this way, the security standard is considerably lowered for the entire communications network as described initially.

As protection against the method for address falsification described above, it is proposed to carry out an enquiry in the form of a callback from the terminal of the second subscriber B to the originating address transmitted by the first subscriber A during the signaling Si which takes place between the terminals of the first subscriber A and of the second subscriber B. The originating address transmitted in this case corresponds to the content of the “Contact:” field or to the content of the “From:” field of the INVITE message transmitted in the call request by the terminal of the first subscriber A. This callback is used for verifying the identity of the first subscriber A before the establishment of a communications link: in this manner, it is checked, according to the invention, whether the first subscriber A allocated to the transmitted originating address corresponds to the subscriber actually calling. In the case where the first subscriber A has specified the correct originating address, the terminal of the first subscriber A answers the callback with an acknowledgement. In the case where a malicious subscriber M has forged his originating address by specifying the originating address of the first subscriber A, the terminal of the first subscriber A answers and informs the terminal of the second subscriber B in this manner that the first subscriber A is not identical with the actual caller.

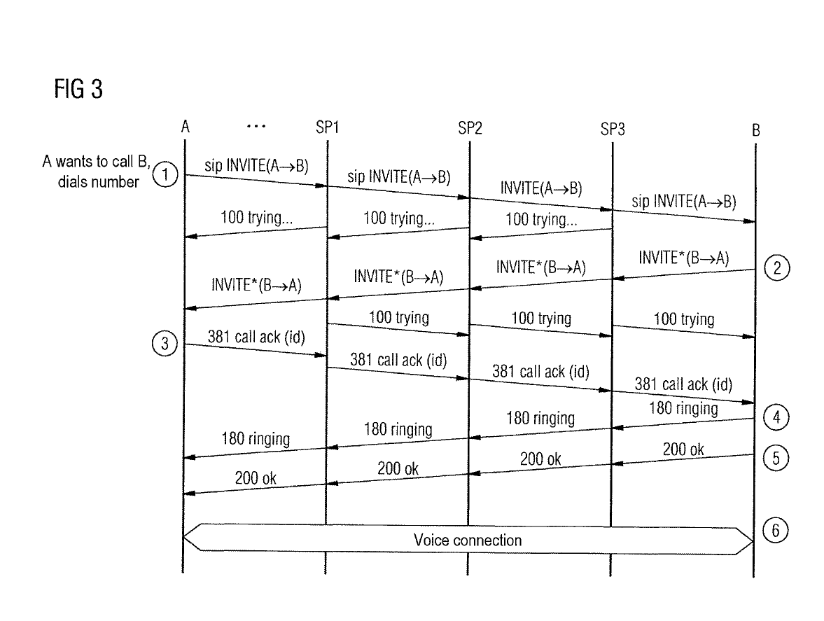

FIG. 3 shows the signaling Si, based on the SIP protocol, between the terminal of the first subscriber A and the terminal of the second subscriber B for the situation described in FIG. 1: in a first step 1, the terminal of the first subscriber A sends an INVITE message to the terminal of the second subscriber B. After receiving the INVITE message, the terminal of the second subscriber B sends back a modified INVITE message INVITE* to the terminal of the first subscriber A in a second step. As a destination address, the originating address (caller ID) specified in the original message in the SIP header “Contact:” is preferably used. As an alternative, the caller ID used in the SIP header “From:” can be used. The modification of the INVITE* message compared with the original INVITE message consists in that it includes an additional entry in the form of an additional header or of an additional field in the body of the message. This additional entry is used for informing the terminal of the first subscriber A that the callback is not a regular call but an acknowledgement request. In the case where a terminal involved does not implement the extension of the SIP protocol by the additional entry according to the invention, the alternative INVITE* message is modified in such a way that the terminal of the first subscriber A reliably does not signal an incoming call, for example by the selection of a zero codec previously not present and defined especially for the present purpose, or by at least another entry in the INVITE* message which ensures that the terminal of the first subscriber A reliably does not signal an incoming call.

For the case shown in FIG. 3 where the terminal of the first subscriber A supports the method according to the invention, the terminal of the first subscriber A answers, in a third step 3, with a pseudo acknowledgement of the INVITE* message, preferably with a return code 381 “call ack”. The terminal of the first subscriber A then sends, in a separate header field, for example in a field “Ack Call ID:” or, as an alternative, in the body of the message, the content of the “Call-ID:” field again, that is to say the call identification (Call ID) which was transmitted with the original INVITE message. The terminal of the second subscriber B checks the information contained in the “Ack Call ID:” header in a fourth step 4. In the case where the entry in the “Ack Call ID:” header does not match the call ID originally transmitted, the terminal of the second subscriber B rejects the call request of the first subscriber A. In the case shown in FIG. 3, the entry in the “Ack Call ID:” header matches the call ID originally transmitted and the terminal of the second subscriber B transmits an acknowledgement to the terminal of the first subscriber A in a fifth step 5. The call request is thus accepted and in a sixth step, a voice connection, for example, is established between the first subscriber A and the second subscriber B.

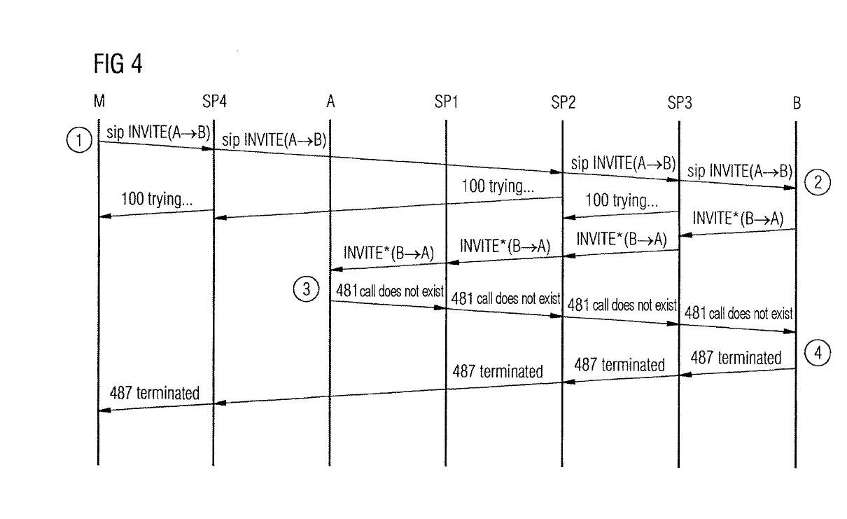

For the case shown in FIG. 2 of a forged originating address in which a SPIT originator M directs a call request via a fourth SIP server SP4, which is not securely configured, to the second subscriber B, the method according to the invention proceeds as shown in FIG. 4:

In a first step 1, the SPIT originator M transmits out of a fifth communications subnetwork N5 a call request in the form of an SIP INVITE message via the insecurely configured fourth SIP server SP4 to the second subscriber B. The fourth SIP server SP4 is configured insecurely, for example, in as much as it accepts and forwards a call request without checking whether the requesting subscriber is trustworthy. In the INVITE message, the originating address of the first subscriber A is specified with malicious intent instead of the originating address of the SPIT originator M. The INVITE message is conducted via the second SIP server SP2 which mistakenly trusts the fourth SIP server SP4 and then via the third SIP server SP3 to the terminal of the second subscriber B. Before an incoming call is signaled, the terminal of the second subscriber B checks in a second step 2 the identity of the calling subscriber by sending the modified INVITE* message to the terminal of the first subscriber A according to the method according to the invention. The terminal of the first subscriber A receives the modified INVITE* message and answers in a third step 3, for example with the transmission of code 481 for “call/transaction does not exist”. The terminal thereupon rejects the call request in a fourth step 4, for example by transmitting the code 487 for “terminated”.

In addition to the scenarios represented in the figures, the method according to the invention can also be used in the case of an asymmetric call routing if the terminal of the first subscriber A can be reached from the terminal of the second subscriber B.

In the case of a firewall installed at a subscriber A, B, dynamic “pinholing” can be applied for guaranteeing the method according to the invention.

The method according to the invention can also be carried out if it is not explicitly supported by one or more SIP servers, SP1-SP4.

Instead of the SIP protocol elements shown in the figures, other protocol elements, to be defined, can also be used for carrying out the method according to the invention. As an alternative, a suitable protocol, to be defined, can be used for the purpose of the acknowledgement request.

The charging for the callback according to the invention for verifying the identity of the first caller A can be carried out separately from the standard signaling of a call request. The callback according to the invention can also be offered, for example, free of charge by a network operator.

In a further embodiment of the invention, in the case where the terminal of the first subscriber A does not support the method according to the invention, the terminal of the second subscriber B sends an INVITE message to the terminal of the first subscriber A which is modified, for example, in such a manner that it is rejected by the terminal of the first subscriber A. For this purpose, a coding which is not generally supported is preferably used in the SIP body of the INVITE message. As an alternative, the INVITE message can request a codec which is not generally known. The answer of the terminal of the first subscriber A to an INVITE message modified in this manner includes, for example, a code 415 for “unsupported media type”. This answer indicates to the terminal of the second subscriber B that the originating address transmitted in the INVITE message originally transmitted does not match the address of the terminal of the first subscriber A and it rejects the call request.

In a further embodiment of the invention, the terminal of the first subscriber A transmits, as a response to the modified INVITE* message, additionally the original call identification to the terminal of the second subscriber B.

In a further embodiment of the invention, the terminal of the second subscriber B transmits the original call identification or a part thereof in the acknowledgement request to the terminal of the first subscriber A for signaling to the terminal of the first subscriber A by this means that this is an enquiry for acknowledgement of the identity of the first subscriber A.

In a further embodiment of the invention, at least one statistics counter for logging successful and unsuccessful attempts of call requests is run in the communications network, an acknowledgement request and an answer to an acknowledgement request being of no significance for the logging.

In a further embodiment of the invention, at least one statistics counter is run for logging successful and unsuccessful acknowledgement requests in the communications network. The at least one statistics counter can be implemented, for example, on one or more SIP servers SP1-SP4. In this way the success rate of the acknowledgement requests can be monitored.

In a further embodiment of the invention, the at least one statistics counter for logging successful and unsuccessful acknowledgement requests is monitored and originating addresses occurring clustered are blocked for a predetermined time.

In a further embodiment of the invention, a suitable proxy device, for example, can be used for informing the home network operator of the call request in the case where the first subscriber A is in the state of “roaming”. In this arrangement, the proxy device can also be used for positively answering an acknowledgement request and/or for a diversion, set up automatically, for example, to the first subscriber A who is not located in the home network.

In a further embodiment of the invention, the terminal of the first subscriber A informs the terminal of the second subscriber B of its support for the method according to the invention by means of a suitable entry in the header and/or body of the INVITE message in the first step 1 of the method according to the invention.

In a further embodiment of the invention, the method according to the invention can be combined with the use of a white list and/or a method for anonymous call rejection and/or a display of the directory number of the calling first subscriber A on the terminal of the second subscriber B.

In a further embodiment of the invention, the communications link is an e-mail-based communications link.

In a further embodiment of the invention, a device A, B, SP1, SP2, SP3, SP4 carrying out the method according to the invention only checks an originating address if this originating address differs from the originating address of the requesting device. In this way, continuous loops of checks can be avoided.

1. A method for verifying an originating address transmitted in a call request, comprising:
establishing a communications link in an IP communications network between a terminal of a first subscriber and a terminal of a second subscriber; and
transmitting a verification of the originating address transmitted in the call request before the establishment of the communications link using an acknowledgement request of the terminal of the second subscribers to the transmitted originating address and an evaluation of a response to the acknowledgement request by the terminal of the second subscribers.

2. The method as claimed in claim 1, wherein the terminal, the address of which matches the transmitted originating address,
transmits an acknowledgement to the terminal of the second subscriber when the terminal is identical with the terminal of the first subscriber, and
transmits a message corresponding to a rejection to the terminal of the second subscriber when the terminal is not identical with the terminal of the first subscriber.

3. The method as claimed in claim 1, wherein the terminal of the first subscriber, as a response to the acknowledgement request, transmits, in addition to the acknowledgement, a call identification identifying the call request to the terminal of the second subscribers.

4. The method as claimed in claim 1, wherein the terminal of the second subscriber transmits at least part of a call identification identifying the call request in the acknowledgement request to the terminal of the first subscribers.

5. The method as claimed in claim 1, wherein the acknowledgement request is transmitted by an SIP server directly preceding the terminal of the second subscribers.

6. The method as claimed in claim 1, wherein the acknowledgement request is answered by an SIP server directly preceding the terminal of the first subscriber.

7. The method as claimed in claim 1, wherein in the communications network, at least one statistics counter for logging successful and unsuccessful attempts of call requests is run without taking into consideration acknowledgement requests and answers to the acknowledgement requests.

8. The method as claimed in claim 1, wherein in the communications network, at least one statistics counter is run for logging successful and unsuccessful acknowledgement requests.

9. The method as claimed in claim 8, wherein the at least one statistics counter for logging successful and unsuccessful acknowledgement requests is monitored and originating addresses occurring clustered are blocked for a predetermined time.

10. The method as claimed in claim 1, wherein where the first subscriber is in the state of “roaming”, a suitable proxy device can be used for informing a home network operator of the first subscriber of the call request, wherein the proxy device can be used for positively answering an acknowledgement request and/or for a diversion, set up automatically, to the first subscriber who is not located in the home network.

11. The method as claimed in claim 1, wherein the terminal of the first subscriber informs the terminal of the second subscriber of its support in the first step.

12. The method as claimed in claim 1, wherein a white List and/or a method for anonymous call rejection and/or a display of the directory number of the calling first subscriber on the terminal of the second subscribers is used.

13. The method according to claim 1, wherein the communications link is an e-mail-based communications link.

14. An arrangement for verifying an originating address transmitted in a call request establishing a communications link in an IP communications network between a terminal of a first subscriber and a terminal of a second subscribers, comprising:
an acknowledgement device to send an acknowledgement request to the originating address transmitted;
answering device for answering the acknowledgement request; and
evaluation device for evaluating an answer to the acknowledgement request.

15. A device for verifying an originating address transmitted in a call request for establishing a communications link in an IP communications network between a terminal of a first subscriber and a terminal of a second subscriber comprising an acknowledgement device for sending an acknowledgement request to the originating address transmitted.

16. A device for verifying an originating address transmitted in a call request for establishing a communications link in an IP communications network between a terminal of a first subscriber and a terminal of a second subscriber comprising an answering device for answering the acknowledgement request.

17. A device for verifying an originating address transmitted in a call request for establishing a communications link in an IP communications network between a terminal of a first subscriber and a terminal of a second subscriber comprising an evaluation device for evaluating an answer to an acknowledgement request.

18. The device as claimed in claim 15, wherein the device is a terminal.

19. The device as claimed in claim 15, wherein the device is a switching center.

20. The device as claims in claim 18, wherein the terminal is a telephone.
